(19) United States
(12) Patent Application Publication
(10) Pub. No.: US 2009/0146028 A1
(43) Pub. Date: Jun. 11, 2009

(54) ELEVATING DISPLAY DEVICE FOR THE WORKTABLE OF A MANUAL PLANER

(76) Inventor: Bor-Yann CHUANG, Taiping City (TW)

Correspondence Address: SINORICA, LLC, 528 FALLSGROVE DRIVE, ROCKVILLE, MD, 20850, US

(21) Appl. No.: 11/953,043

(22) Filed: Dec. 8, 2007

(51) Int. Cl. F16M 11/24

(52) U.S. Cl. 248/188.2

(57) ABSTRACT

An elevating display device for the worktable of a manual planer includes a driving unit assembled at one side of a movable worktable and provided with a fixed rod fitted with a sliding sleeve to be moved together with the worktable. The sliding sleeve is fixed with an engaging plate having one side disposed with engaging teeth so that when moved by the sliding sleeve, the engaging plate can actuate an interacting unit at the front side of the driving unit to move. The interacting unit includes a graduated dial having its circumference disposed with signal sets preset in number, and a gear engaged with the engaging teeth of the engaging plate. A sensing-and-reading head engaged on the circumference of the graduated dial functions to sense a signal of the signal sets and transmit the signal to a display member for indicating an adjusted numerical value of the height of the worktable.

### BACKGROUND OF THE INVENTION

1. Field of the Invention

This invention relates to an elevating display device for the worktable of a manual planer, particularly to one able to accurately measure a height adjusting numerical value of the worktable of a manual planer.

2. Description of the Prior Art

A conventional manual planer, as shown in FIG. 1, includes a stationary machine base 1, a movable worktable 2 adjustable to be moved up or down, and an elevating mechanism 3 installed at one side of a joint portion of the machine base 1 and the worktable 2 for adjusting the worktable 2 to move up and down. The machine base 1 is fixed thereon with a graduated rule 4 with graduations 5 for indicating a relative displacement distance of the worktable 2 sliding on the machine base 1, and the worktable 2 is fixed thereon with an index 6 corresponding to the graduations 5 of the graduated rule 4. Thus, by interaction and according to a sliding distance of the worktable 2, the index 6 will point at the graduations 5 on the graduated rule 4 to indicate an elevating height of the worktable 2. However, the gap between every two graduations 5 on the graduated rule 4 is very small so graduations indicated cannot clearly be recognized and read, likely to cause errors in visual measurement. In addition, the graduated rule 4 is located under the worktable 2 so a user has to bend or squat in order to see an indication value of the graduations 5, inconvenient in use.

### SUMMARY OF THE INVENTION

The objective of this invention is to offer an elevating display device for the worktable of a manual planer, including a driving unit assembled at one side of a movable worktable and provided with a fixed rod fitted thereon with a sliding sleeve to be moved together with the worktable. The sliding sleeve is secured with an engaging plate having at least one side disposed with engaging teeth, so that when moved by the sliding sleeve, the engaging plate can actuate an interacting unit positioned at the front side of the driving unit to move. The interacting unit consists of a graduated dial and a gear engaged with the engaging teeth of the engaging plate. When driven by the driving unit to move, the interacting unit will actuate the graduated dial to rotate and simultaneously a sensing-and-reading head engaged on the circumference of the graduated dial will sense signals of plural signal sets disposed on the graduated dial and transmit the signals to a display member, which can directly indicate an adjusted numerical value of the height of the worktable. The elevating display device in the present invention is convenient in operating and able to accurately indicate an adjusted numerical value of the height of the worktable, enabling an operator to read the numerical value precisely without causing visual errors.

### BRIEF DESCRIPTION OF DRAWINGS

This invention will be better understood by referring to the accompanying drawings, wherein:

FIG. 1 is a perspective view of a conventional manual planer with a worktable provided with an elevating graduations indicating device;

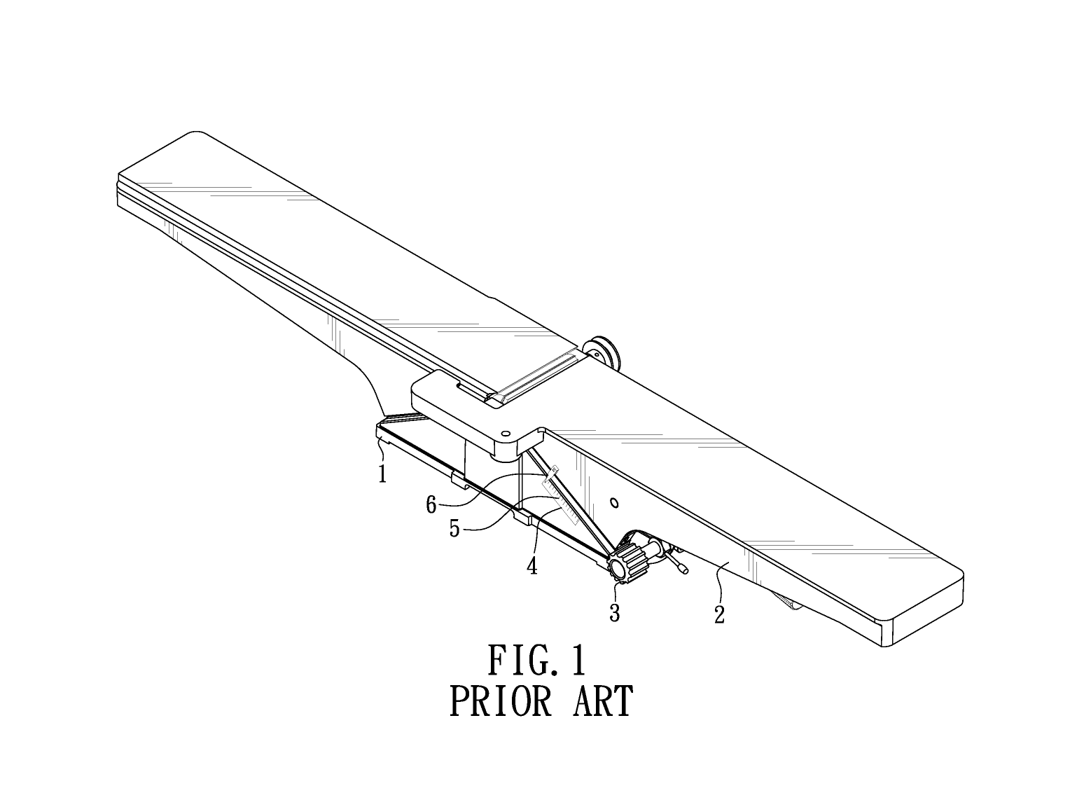

FIG. 2 is a front perspective view of an elevating display device for the worktable of a manual planer in the present invention;

FIG. 3 is a rear perspective view of the elevating display device for the worktable of a manual planer in the present invention;

FIG. 4 is an exploded perspective view of the elevating display device for the worktable of a manual planer in the present invention;

FIG. 5 is a cross-sectional view of the elevating display device for the worktable of a manual planer in the present invention;

FIG. 6 is a front cross-sectional view of the elevating display device for the worktable of a manual planer in a using condition in the present invention; and

FIG. 7 is a rear cross-sectional view of the elevating display device for the worktable of a manual planer in a using condition in the present invention.

### DETAILED DESCRIPTION OF THE PREFERRED EMBODIMENT

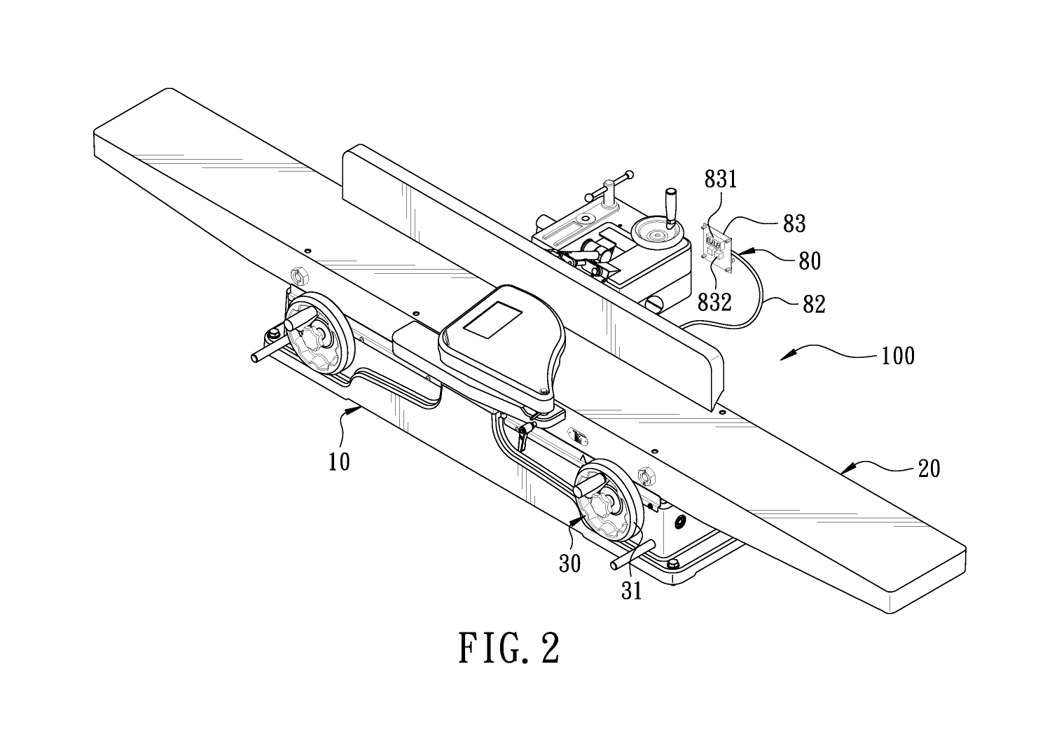

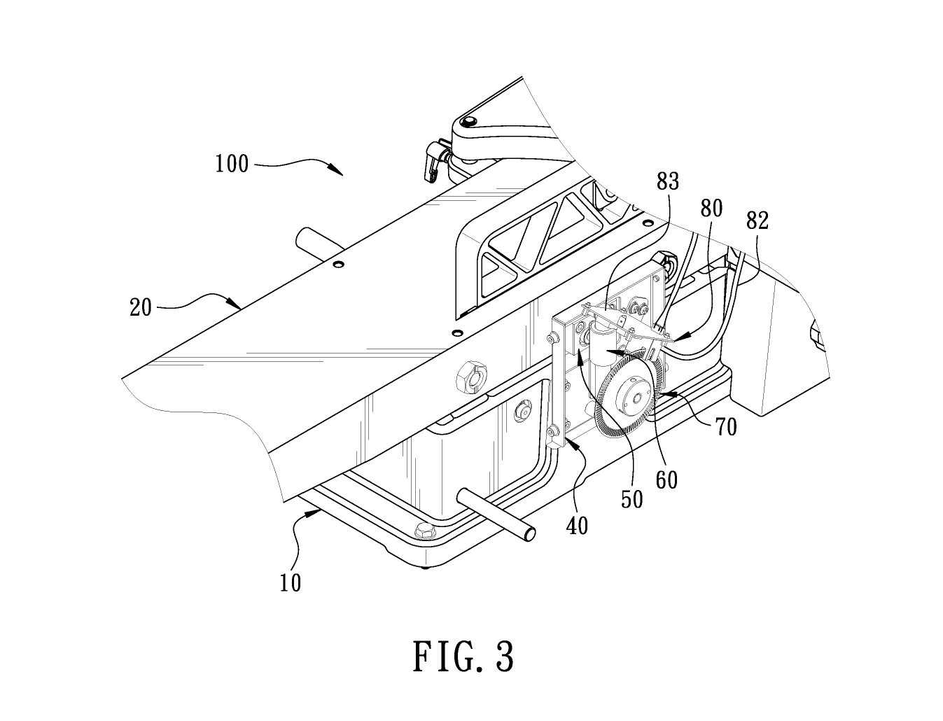

A preferred embodiment of an elevating display device for the worktable of a manual planer 100 in the present invention, as shown in FIGS. 2 and 3, includes a stationary machine base 10, a movable worktable 20 and an elevating mechanism 30. The elevating mechanism 30 is provided with a rotary disk 31 to be rotated for adjust the worktable 20 to move up or down, and the worktable 20 has its rear side installed with an elevating display device 40 for detecting and indicating a height numerical value of the worktable 20 after the elevating mechanism 30 is adjusted. The elevating display device 40 is composed of a fixed block 50, a driving unit 60, an interacting unit 70 and a sensor unit 80.

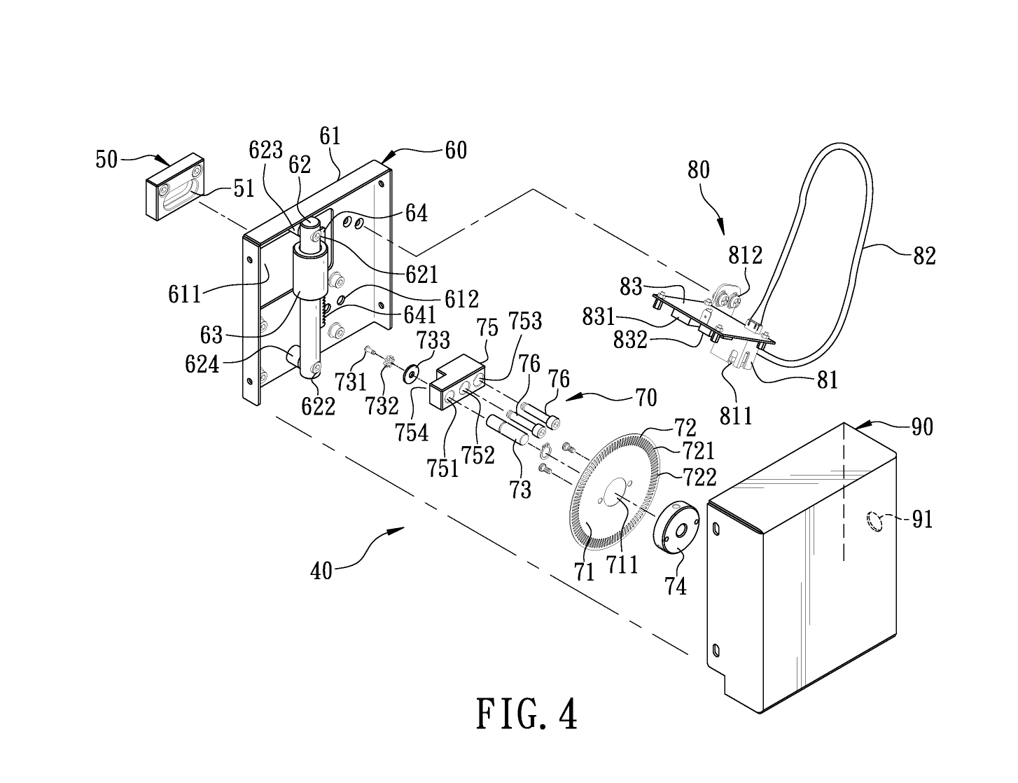

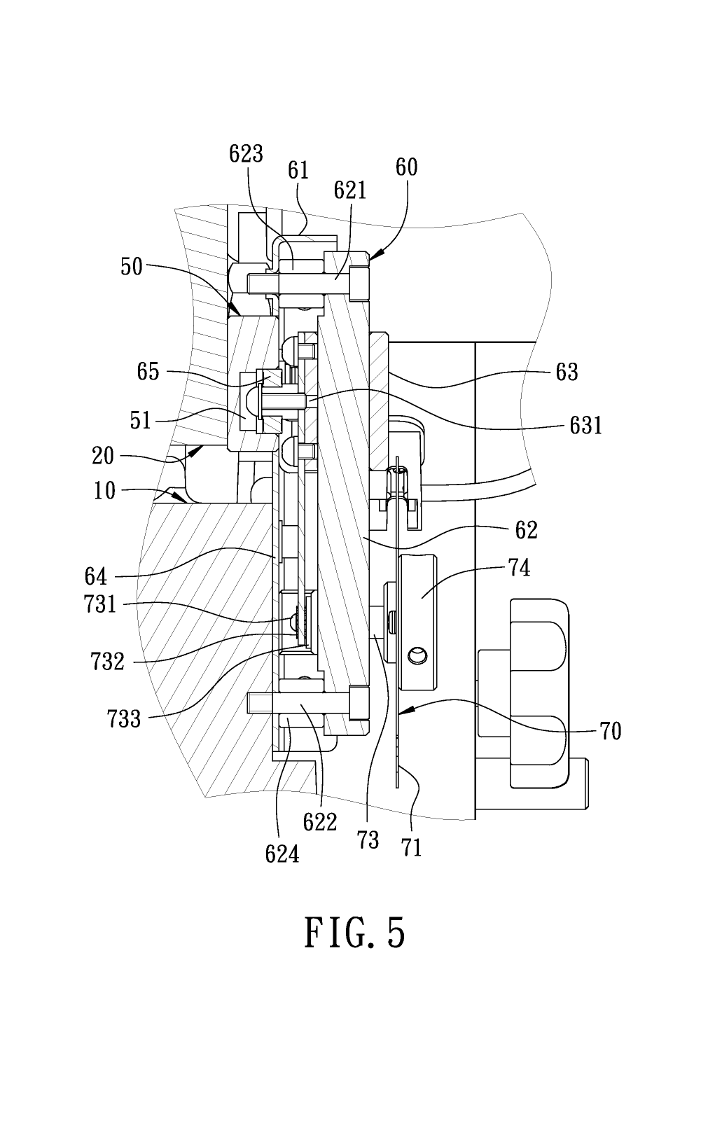

The fixed block 50, referring to FIGS. 4 and 5, is a rectangular block transversely secured at the rear side of the worktable 20 and transversely bored with a long oval slide groove 51 parallel to the worktable 2.

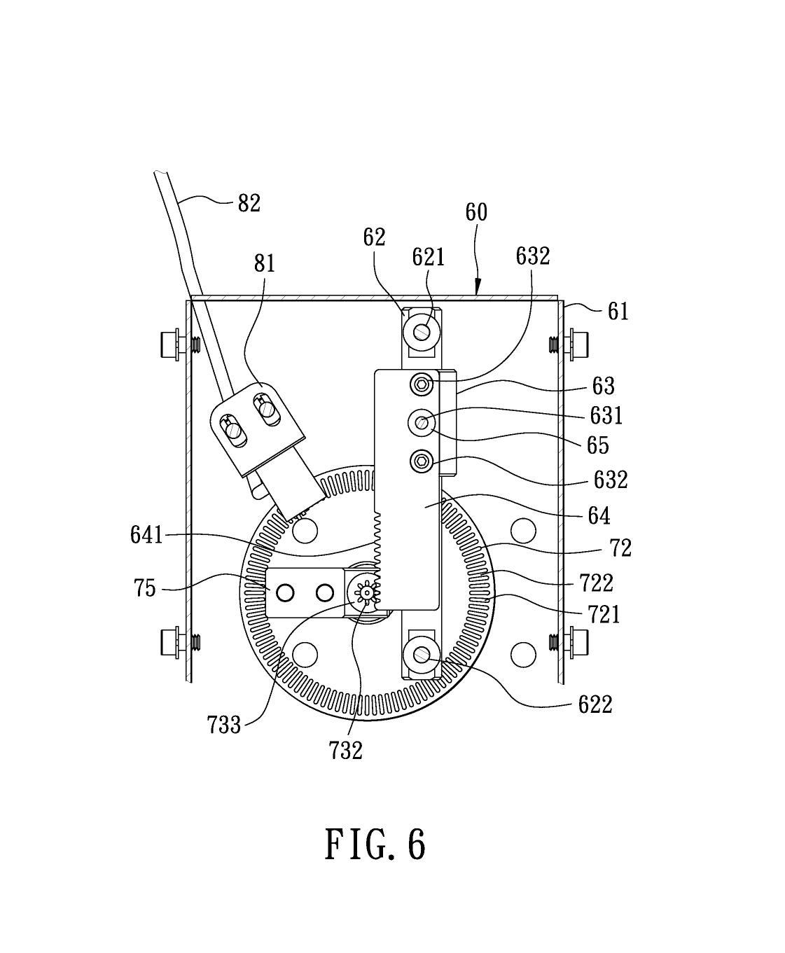

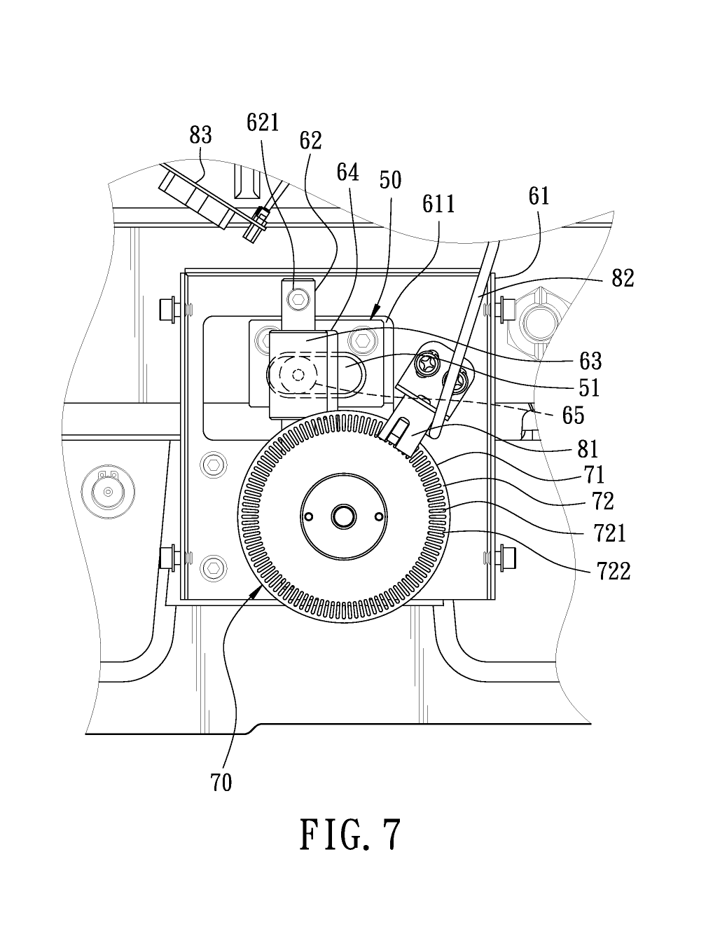

The driving unit 60 is provided with a square and shell-shaped assembly base 61 provided with a cover 90 bored with a circular hole 91 in its right side. The assembly base 61 has its left side bored with an opening 611 at a location corresponding to the fixed block 50 for receiving the fixed block 50 therein to enable the fixed block 50 to shift in the space of the opening 611. The assembly base 61 has its lower end secured on the rear side of the machine base 10. Further, the assembly base 61 is axially fixed with a fixed rod 62 having its upper and lower end respectively locked on the left end of the assembly base 61 by means of two bolts 621 and 622, which are respectively inserted through the upper and the lower end of the fixed rod 62, and then respectively inserted through two transverse bars 623 and 624 and fixedly locked on a corresponding side of the assembly base 61, with a gap formed between the fixed rod 62 and the assembly base 61. The fixed rod 62 is fitted thereon with a cylindrical sliding sleeve 63 facing the opening 611 of the assembly base 61 and able to slide up and down on the fixed rod 62. Referring to FIG. 6, the sliding sleeve 63 has one lateral side secured with the upper end of an engaging plate 64 by means of a shaft 631 and bolts 632 to enable the engaging plate 64 to actuate the sliding sleeve 63 to slide between the two transverse cylinders 623 and 624 on the fixed rod 62. The engaging plate 64 has its left side edge provided with engaging teeth 641, and the shaft 631 of the engaging plate 64 has another end extended into the slide groove 51 of the fixed block 50. Further, the shaft 631 is pivotally fitted thereon with a rotatable member 65 (a bearing) having its outer circumference exactly pushing against and restrictedly positioned on the circumferential wall of the slide groove 51 of the fixed block 50, as shown in FIG. 7. Thus, when the worktable 20 is actuated to slide and elevate transversely, the rotatable member 65 will be driven by the worktable 20 to rotate simultaneously and actuate the sliding sleeve 63 to move up and down axially on the fixed rod 62.

The interacting unit 70 is assembled at the front side of the driving unit 60 to be moved together with the engaging plate 64, provided with a circular plate graduated dial 71 having its circumference disposed with signal sets 72 preset in number at preset locations. The signal sets 72 consist of lots of notch-shaped transparent portions 721 and opaque portions 722, which are staggered and arranged equidistantly around the circumference of the graduated dial 71. The graduated dial 71 has a circular hole 711 its center bored, and an interacting rod 73 is pivotally inserted through the circular hole 711 and then inserted in and fixed with a circular cover 74. The interacting rod 73 has an end inserted through a transverse rectangular interacting block 75, which is transversely and orderly bored with three through holes 751, 752 and 753 positioned in parallel, and the interacting rod 73 is inserted through the through hole 751 to let the interacting block 75 extended diametrically along the inner side of the graduated dial 71 and positioned parallel to the graduated dial 71. The interacting block 75 is adjacent to the engaging plate 64 and positioned at the same side of the engaging teeth 641. Two shafts 76 are respectively inserted through the through holes 752 and 753 of the interacting block 75, respectively having one end secured on the inner side of the graduated dial 71 and the other end inserted through an insert hole 612 of the assembly base 61. Thus, the interacting block 75 can be restrictedly positioned at one side of the graduated dial 71 but cannot be moved bias by rotating of the graduated dial 71. Further, the interacting block 75 has its rear end corresponding to the engaging teeth 641 formed with a dented corner 754 matching with the through hole 751. After inserted through the dented corner 754, the interacting rod 73 has its end locked with a bolt 731 pivotally fitted thereon with a planetary gear 732 to be engaged with the engaging teeth 641 of the engaging plate 64 and fixed in position by a gasket 733.

The sensor unit 80 is positioned at the right circumference of the graduated dial 71 and provided with a sensing-and-reading head 81 having its front end cut with an engaging notch 811 to be engaged with the outer circumference of the graduated dial 71 and corresponding to the signal sets 72. The sensing-and-reading head 81 has one side bent and extended to form a plate 812 to be secured on a corresponding side of the assembly base 61, with a preset angle formed between the sensing-and-reading head 81 and the graduated dial 71 so as to enable the sensing-and-reading head 81 to sense signals of the signal sets 72 of the graduated dial 71. The sensing-and-reading head 81 has another end combined with one end of a flexible signal wire 82, which has its free end inserted through the circular hole 91 of the cover 90 and assembled with a display member 83 positioned outside the cover 90 and able to be adjusted in its level above the worktable 20 by the flexible signal wire 82. The indicating member 83 is provided inside with a micro-chip set (not shown) for receiving signals sent out by the sensing-and-reading head 81, and has its outer side disposed with a digit indicating faceplate 831 for indicating an adjusted numerical value of the height of the worktable 20, and plural set switches 832 for carrying out other affiliated functions, such as a function of changeover between metric system and British system for a numerical value indicated by the digit indicating faceplate 831 or a function of return-to-zero.

To adjust the movable worktable 20 to move up or down on the machine base 10, firstly, the rotary disk 31 of the elevating mechanism 30 is turned in a preset direction. When the worktable 20 is moved, the driving unit 60 at the opposite side of the elevating mechanism 30 will be actuated to move, and the rotatable member 65 on the shaft rod 631 of the sliding sleeve 63 will be actuated to push against and turn around the inner side of the slide groove 51 of the fixed block 50, keeping the driving unit 60 from moving bias transversely, and simultaneously the sliding sleeve 63 will be actuated to slide up and down on the fixed rod 62.

Referring to FIGS. 6 and 7, when the worktable 20 is moved up or down, the sliding sleeve 63 will be actuated to slide up or down, and synchronously the planetary gear 732 of the interacting unit 70, which is engaged with the engaging teeth 641 of the engaging plate 64 on the sliding sleeve 63, will be driven to rotate and actuate the interacting rod 73 and the graduated dial 71 to rotate. At this time, the sensing-and-reading head 81 engaged on the graduated dial 71 will sense a phase-difference signal produced by alteration of the transparent portions 721 and the opaque portions 722 of the signal sets 72, and then the signal will be transmitted to the micro-chip set (not shown) in the display member 83 at one end of the signal wire 82 connected with the sensing-and-reading head 81. Meanwhile, the micro-chip set will distinguish priority or posteriority of the phase difference to produce a displacement difference of moving upward or downward and transmit the displacement difference to the digit indicating faceplate 831 outside the display member 83 to directly indicate an adjusted numerical value of the height of the worktable 20 and also start the set switches 832 on the indicating faceplate 831 to have the indicated numerical value changed over between metric system and British system or returned to zero in accordance with an operator's requirements.

As can be understood from the above description, this invention has the following advantages.

1. The interacting unit is driven by the driving unit to move and actuate the graduated dial to rotate, and simultaneously the sensing-and-reading head will sense a signal via the signal sets on the graduated dial and transmit the signal to the display member for directly and accurately indicating an adjusted numerical value of the height of the worktable to be read conveniently by an operator, impossible to cause visual errors and able to elevate precision in adjustment of the worktable.

2. The display member of the sensor unit can be adjusted in position by the flexible signal wire; therefore, an operator can adjust the display member to a proper position above the worktable for facilitating reading the numerical value indicated thereon. In addition, the display member is disposed thereon with a plurality of set switches having a function of changeover of indicated numerical value between metric system and British system or a function of return-to-zero, attaining multifunction practicability.

While the preferred embodiment of the invention has been described above, it will be recognized and understood that various modifications may be made therein and the appended claims are intended to cover all such modifications that may fall within the spirit and scope of the invention.

I claim:

1. An elevating display device for the worktable of a manual planer comprising a stationary machine base and one movable worktable, said machine base provided thereon with an elevating mechanism for actuating said worktable to move up or down, said worktable having one side installed with an elevating display device, said elevating display device comprising:
a driving unit assembled at one side of said movable worktable, said driving unit provided with a fixed rod fitted thereon with a sliding sleeve, said sliding sleeve able to be moved up and down together with said worktable, said sliding sleeve fixed thereon with an engaging plate having one side disposed with engaging teeth;
an interacting unit positioned at a front side of said driving unit and actuated to move by said engaging plate, said interacting unit provided with a graduated dial, said graduated dial having its circumference disposed with a plurality of signal sets at preset locations, said graduated dial having its center pivotally assembled with an interacting rod, said interacting rod inserted in an interacting block, said interacting block pivotally fixed with a gear engaged with said engaging teeth of said engaging plate; and
A sensor unit assembled at one side of said graduated dial and provided with a sensing-and-reading head, said sensing-and-reading head engaged on outer circumference of said graduated dial and corresponding to said signal sets, said sensing-and-reading head functioning for sensing signals of said signal sets on said graduated dial and transmitting the signals to an display member connected with an end of said sensor unit.

2. The elevating display device for the worktable of a manual planer as claimed in claim 1, wherein said worktable has one side secured with a fixed block transversely bored with a slide groove along said worktable, and said driving unit is provided with an assembly base having its upper end bored with an opening matching with said fixed block for receiving said fixed block therein, letting said fixed block have a moving space, said assembly base having its lower end secured on said machine base, said fixed rod of said driving unit having its upper and lower end firmly fixed on said assembly base.

3. The elevating display device for the worktable of a manual planer as claimed in claim 2, wherein said fixed rod has an outer side of its upper and lower end respectively inserted therethrough with a bolt, said bolt continuously inserted through a transverse bar to secure said fixed rod on a corresponding side of said assembly base, letting said engaging plate on said fixed rod restrictedly positioned between said transverse bars.

4. The elevating display device for the worktable of a manual planer as claimed in claim 2, wherein said engaging plate is secured on said sliding sleeve by a shaft that is extended into said slide groove of said fixed block, said shaft pivotally fitted thereon with a rotatable member, said rotataber member exactly received in said slide groove and pushing against an inner circumferential wall of said slide groove, said rotatable member actuated by said worktable to rotate and drive said sliding sleeve of said driving unit to slide up or down on said fixed rod when said worktable is shifted up or down.

5. The elevating display device for the worktable of a manual planer as claimed in claim 1, wherein said signal sets on said graduated dial of said interacting unit are provided with transparent portions and opaque portions staggered and arranged equidistantly around circumference of said graduated dial.

6. The elevating display device for the worktable of a manual planer as claimed in claim 2, wherein said interacting block is diametrically extended along inner side of said graduated dial and parallel to said graduated dial, said interacting block adjacent to said engaging plate and positioned at a same side of said engaging teeth of said engaging plate, said interacting block inserted with one shaft, said shaft connected with said graduated dial and pivotally fixed on said assembly base to prevent said interacting block from moving bias.

7. The elevating display device for the worktable of a manual planer as claimed in claim 2, wherein said sensor unit has one side bent and extended to form a plate to be secured on a corresponding side of said assembly base, and between said sensing-and-reading head and said graduated dial is formed a preset angle.

8. The elevating display device for the worktable of a manual planer as claimed in claim 1, wherein said display member is installed inside with a micro-chip set for receiving signals output by said sensing-and-reading head, having its outside disposed with a digit-indicating faceplate and one set switch, said set switch functioning to carry out changeover between metric system and British system for numerical value indicated by said digit-indicating faceplate.

9. The elevating display device for the worktable of a manual planer as claimed in claim 1, wherein said sensing-and-reading head and said display member of said sensor unit are connected by an adjustable and flexible signal wire, said display member able to be adjusted in position by said signal wire.

10. The elevating display device for the worktable of a manual planer as claimed in claim 1, wherein said rotatable member is a bearing.
